(19) United States
(12) Patent Application Publication
(10) Pub. No.: US 2011/0109504 A1
(43) Pub. Date: May 12, 2011

(54) Alternative Geolocation Capabilities

(75) Inventor: Jonathan W. Ellis, Austin, TX (US)

(73) Assignee: Advanced Communication Concepts, Inc., Austin, TX (US)

(21) Appl. No.: 12/617,090

(22) Filed: Nov. 12, 2009

(51) Int. Cl. G01S 19/46; G01S 3/02

(52) U.S. Cl. 342/357.29; 342/464

(57) ABSTRACT

A global positioning system (GPS) receiver receives signals from at least three or more high-definition television (HDTV) transmitters at HDTV transmitting power and frequency bands. The GPS receiver includes dynamic reconfigurable logic hardware to decode data patterns (i.e., dynamic algorithm patterns) in the received signals to compute and/or identify GPS receiver's physical location.

### BACKGROUND

An example of a Global Positioning System (GPS) network currently and commercially available to the public is “Navstar.” Navstar is a global navigation satellite system (GNSS) operated by United States Department of Defense (DOD). Navstar can be used to transmit signals from a satellite to a GPS receiver. The GPS receiver can be a passive device that computes and/or calculates distances of the GPS receiver relative to the satellite that transmitted the signal.

In an implementation, the GPS receiver includes a time clock that can be synchronized with an atomic clock on board the satellite in the GPS network. The time clock may be synchronized through the transmitted signals from the satellite in the GPS network; however, the transmitted signals are often limited to line of sight conditions (between the GPS receiver and the transmitting satellite). In other implementations, the transmitting satellite typically transmits signals at a relatively low transmitting power (i.e., about 50 watts), which can be prone to signal jamming and/or subjected to noise and interferences along the path of transmission.

### SUMMARY

The following presents a simplified summary in order to provide a basic understanding of some aspects of the disclosed subject matter. This summary is not an extensive overview of the disclosed subject matter, and is not intended to identify key/critical elements or to delineate the scope of such subject matter. A purpose of the summary is to present some concepts in a simplified form as a prelude to the more detailed description that is presented later.

In an implementation, a global positioning system (GPS) navigational system includes transmitters that transmit signals—containing rapidly changing algorithms—at a relatively high transmitting power and at a certain frequency bands. For example, a high-definition television (HDTV) transmitter transmits signals at HDTV transmitting power (e.g., 100,000 watts) and frequency bands of very high frequencies (VHF). The HDTV transmitted signals include the rapidly changing algorithms that are received by a GPS receiver. In other implementations, the GPS receiver includes dynamic reconfigurable logic hardware in processing and/or calculating physical location of the GPS receiver relative to the HDTV transmitter.

To the accomplishment of the foregoing and related ends, certain illustrative aspects are described herein in connection with the following description and the annexed drawings. These aspects are indicative of various ways in which the disclosed subject matter can be practiced, all of which are intended to be within the scope of the disclosed subject matter. Other advantages and novel features can become apparent from the following detailed description when considered in conjunction with the drawings.

### BRIEF DESCRIPTION OF THE DRAWINGS

The detailed description is described with reference to accompanying figures. In the figures, the left-most digit(s) of a reference number identifies the figure in which the reference number first appears. The same numbers are used throughout the drawings to reference like features and components.

FIG. 1 is a block diagram of an exemplary global positioning system (GPS) system.

FIG. 2 is an exemplary implementation for a processor of a high definition television transmitter.

FIG. 3 is a flow chart diagram 300 for an exemplary process of transmitting and receiving signals in the GPS system.

FIG. 4 is an exemplary implementation for a GPS receiver in finding and/or processing received signals.

### DETAILED DESCRIPTION

This disclosure is directed towards systems and methods for implementing a global positioning system (GPS) network that includes rapidly changing algorithms in data streams of transmitted signals. The rapidly changing algorithms can be obtained through a programmable dynamic software algorithm, which can be implemented through dynamic reconfigurable logic hardware. In an implementation, the transmitted signals are transmitted using high-definition television (HDTV) transmitters—at HDTV transmitting power and frequency bands—to overcome “line of sight” limitations. In other words, the transmitted signals are transmitted at a relatively high transmitting power to overcome signal jamming and/or signal interferences produced by structures, mountains, bunkers, and the like, along the path of transmission. In other implementations, the GPS receiver is configured to process the rapidly changing algorithm (received) to compute physical location of the GPS receiver relative to a satellite and/or transmitter in the GPS network. In another implementation, the GPS receiver uses the satellites and/or transmitters' synchronized clocks to adjust a reference timing clock embedded in the GPS receiver (system).

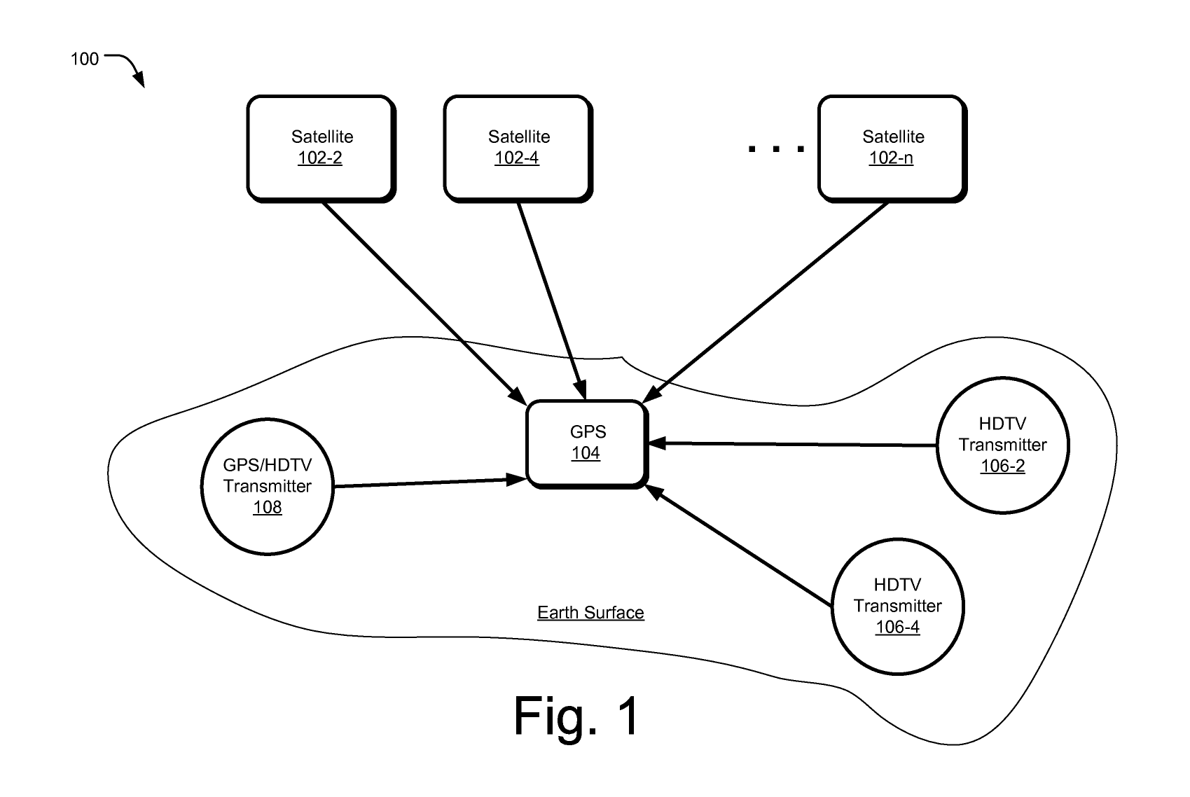

FIG. 1 is a block diagram for a global positioning system (GPS) system 100 that includes satellites 102-2, 102-4, . . . 102-n (where “n” is an integer), a GPS receiver 104, a first high definition television (HDTV) transmitter 106-2, a second HDTV transmitter 106-4, and a GPS/HDTV transmitter 108. In an implementation, the GPS system 100 can be a satellite-based navigation system that includes a network of at least 12 satellites to cover an earth surface. The satellites 102-2, 102-4, . . . 102-n (hereinafter referred to as satellites 102) can be stationed into outer space in order to orbit the earth and to transmit signal information down to the earth surface. The signal information may include sequence of signals (or data streams) that are transmitted in digital format. The signal information may further identify the transmitting satellite (e.g., satellite 102-2) through the data streams (i.e., data pattern) that are included in the transmitted signal.

In an implementation, the data streams include a rapidly changing algorithm (i.e., dynamic algorithm) that is transmitted by the satellites 102. The dynamic algorithm may include data encryption, data compression, data rotation, data identification, and the like, which changes every time period (e.g., every minute). The data encryption, data compression etc. may be contained in the data streams to implement a certain algorithm for a certain period of time. In other implementations, the data streams (i.e., transmitted signal) from the satellites 102 may further include a reference timing clock that is based on an atomic clock on board the satellites 102. The reference timing clock, as further discussed below, can be used by the GPS receiver 104 for processing of received signals.

In an implementation, the GPS receiver 104 receives at least three or more transmitted signals from the satellites 102 (e.g., satellites 102-2, 102-4, and 102-6) in order to compute and identify a physical location of the GPS receiver 104 in the earth surface. The computation and identification of the physical location of the GPS receiver 104 can use speed of light (i.e., 300,000 km/sec) as a basis for calculating the distance travelled by the transmitted signals. As mentioned above, the reference timing clock in the GPS receiver 104 can be synchronized with the atomic clock on board the satellites 102 in order to arrive at the exact distance travelled by the transmitted signals.

In an implementation, at a particular time (e.g., 12:00 noon), the satellites 102 begin to transmit a long, digital pattern called a pseudo-random code. The pseudo-random code may include the data streams that represent the transmitted signal (i.e., modulated signal). At the other end of the earth surface, the GPS receiver 104 may begin to run the same digital pattern at the same reference time (e.g., 12:00 noon). When the transmitted digital pattern (i.e., pseudo-random code) from the satellites 102 are received by the GPS receiver 104, a delay may occur. The delay may include a delay length that is equivalent to the transmitted signal's travel time. The GPS receiver 104 may multiply the delay length with the speed of light to determine the distance and/or how far the transmitted signal has traveled. The calculated distance may include the distance of the GPS receiver 104 (physical location) relative to the transmitting satellites 102.

In the implementation described above, the satellites 102 and the GPS receiver 104 may include the atomic clock and the reference timing clock respectively. The atomic clock and the reference timing clock can be synchronized with a relatively high accuracy (e.g., nanoseconds) to perform an efficient calculation of the distance between the GPS receiver 104 and the satellites 102. In other implementations, such as, when the GPS receiver 104 uses an ordinary clock (e.g., quartz clock), the quartz clock is constantly reset after a certain period of time. To this end, the GPS receiver 104 may use the transmitted digital pattern from the satellites 102 to compute a precise reference time clock for the quartz clock's operation. For example, the GPS receiver 104 receives and computes incoming signals from at least three or more satellites to gauge inaccuracy of the quartz clock that is embedded in the GPS receiver 104. The three or more signals include may include clock inaccuracies that can be proportional to each other. As such, the GPS receiver 104 can compute and calculate average clock inaccuracies in the three or more signals. The average clock inaccuracies can be adapted by GPS receiver 104 in order to synchronize and/or correct the inaccuracies in the quart clock.

The HDTV transmitters 106-2 and 106-4 (hereinafter referred to as HDTV transmitters 106) may include transmitters that transmit signals at a relatively high transmitting power and synchronized reference time clocks. For example, commercial HDTV transmitters that broadcast television signals in digital format, at a relatively high transmitting power, and at a synchronized reference time clocks (e.g., synchronized data stream of vertical retrace time). These types of commercial HDTV transmitters (i.e., HDTV transmitters 106) may transmit the signals in the digital format to increase picture resolution, sound effects, and the like, to a receiving end (e.g., HDTV theaters). In an implementation, the HDTV transmitters 106 (transmitted signals) are used to compute the physical location of the GPS receiver 104. The HDTV transmitters 106 may include a relatively high transmitting power (e.g., 100,000 watts) at HDTV transmitter frequency bands of very high frequency (VHF) to ultra high frequency (UHF)) in order to overcome “line of sight” limitations during propagation of the transmitted signals.

In an implementation, the HDTV transmitters 106 can be configured to transmit the rapidly changing algorithms at the HDTV transmitting power and the HDTV frequency bands. The rapidly changing algorithms are received and processed by the GPS receiver 104 for the calculation of the physical location (i.e., GPS receiver 104) as further discussed in details below.

The GPS/HDTV transmitter 108 may include a type of HDTV transmitter that is typically designed and/or configured to transmit rapidly changing algorithm signals that are received by the GPS receiver 104. As discussed above, the GPS receiver 104 may require and/or receive at least three or more signals to compute and identify the physical location of the GPS receiver 104 in the earth surface. To this end, the GPS receiver 104 may use the transmitted signals in the HDTV transmitters 106, in addition to the GPS/HDTV transmitter 108 signal, for the computation and the identification of the GPS receiver 104 physical location. In an implementation, the GPS/HDTV transmitter 108 include transmitters that transmit signals at a relatively high transmitting power and synchronized reference time clocks.

In other implementations, the satellites 102, HDTV transmitters 106, and the GPS/HDTV transmitter 108 are configured to transmit the rapidly changing algorithms at a relatively high HDTV transmitting power and frequency bands. The rapidly changing algorithms are received by the GPS receiver 104. To this end, the GPS receiver 104 may be configured to receive and process the rapidly changing algorithms in the transmitted signals to function properly. In another implementation, the GPS receiver 104 can distinguish and/or identify the transmitted signals that are transmitted respectively by the satellites 102, HDTV transmitters 106, and the GPS/HDTV transmitter 108.

In an implementation, where the GPS receiver 104 is surrounded by commercial HDTV transmitters (e.g., HDTV transmitters 106) and the GPS/HDTV transmitter 108, the GPS receiver 104 can identify the respective signals received from the HDTV transmitters 106 and the GPS/HDTV transmitter 108. To this end, the GPS receiver 104 may synchronize the GPS receiver 104 reference time clock relative to the received signals. The synchronization, with respect to the received signals from the commercial HDTV transmitters (i.e., HDTV transmitters 106), may be based upon a portion of data streams in the received signals that include a synchronized start for a vertical retrace. The synchronized start for the vertical retrace may include the beaming of an electron gun—inside a commercial HDTV receiver—back to a first line of a predefined HDTV format to implement picture pixels as defined by the data streams. In other implementations, the starts of the vertical retrace in the commercial HDTV transmitters (i.e., HDTV transmitters 106) are accurately synchronized relative to each other. The reason being, the HDTV transmitters 106 and the GPS/HDTV transmitter 108 may include a reference time clock that can synchronized with the atomic clock on board the satellites 102.

In an implementation, the components of the GPS system 100 (i.e., satellites 102, HDTV transmitters 106 and GPS/HDTV transmitter 108) may use a computing device (not shown) to implement the rapidly changing pattern (i.e., dynamic algorithms) in the data streams of the transmitted signals. The computing device may include one or more processors, computer-readable storage media that includes computer-readable instructions that can be executed by the processor, and other type of memories to implement the rapidly changing algorithm in the transmitted signals.

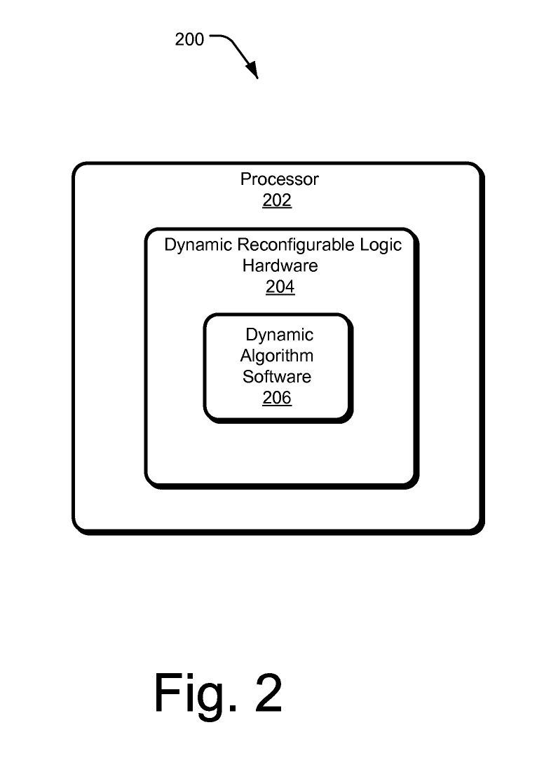

FIG. 2 is an exemplary implementation of a GPS/HDTV transmitter 200. The GPS/HDTV transmitter 200 may include a processor 202, dynamic reconfigurable logic hardware 204, and a dynamic software algorithm 206. The processor 202 may be implemented on a computing device that typically contains a memory or a computer-readable storage media. The memory or the computer-readable storage media can include computer-readable instructions that can be executed by the processor 202 to implement dynamic programmable algorithm (i.e., rapidly changing algorithm) in the GPS/HDTV transmitter 200.

The processor 202 may include the dynamic reconfigurable logic hardware 204 to implement the dynamic algorithm software 206. In an implementation, the dynamic reconfigurable logic hardware is a field programmable gate array (FPGA). The FPGA is a semiconductor device that includes a programmable logic (i.e., logic block components), which can be configured and/or reconfigured to implement a given dynamic algorithm. The configuration and/or reconfiguration may be applied to a portion of the FPGA (e.g., a certain logic block component) without changing and/or affecting the status or configuration of the rest of the logic block components, which can configured and/or reconfigured separately through the dynamic algorithm software 206.

In an implementation, the FPGA is implementing the dynamic algorithm software 206 that includes encryption algorithms, compression algorithm to break up data patterns, data rotation algorithms, identification algorithms, and the like. In other implementations, the encryption algorithms, compression algorithm, identification algorithms etc. are constantly and rapidly changing after a certain period of time. The period of time can be defined through the dynamic algorithm software 206.

The encryption algorithms in a certain data stream may include a portion of bits (e.g., 8 bits) that may indicate the type of encryption used (e.g., first encryption algorithm, second encryption algorithm, etc.) in the present data streams (of the transmitted signals). The encryption algorithms may be stored in the GPS receiver 104 in order to understand and process the received signals that contain the encryption algorithms. The data compression algorithm may include another portion of bits (e.g., 16 bits) in the data streams that may indicate the type of compression used in the present data streams (of the transmitted signals). Similar to the encryption algorithm, the data compression algorithm may be stored in the GPS receiver 104.

In an implementation, the dynamic algorithm software 206 may include a programmable dynamic algorithm to secure transmitted signals that are received by the GPS receiver 104. The programmable dynamic algorithm may include the data encryption, data compression, and the like, that are constantly and/or rapidly changing every period of time (e.g., every 5 minutes). In other implementations, as discussed above, the transmitted signals that contain the dynamic algorithm may be transmitted at HDTV transmitting power and frequency bands.

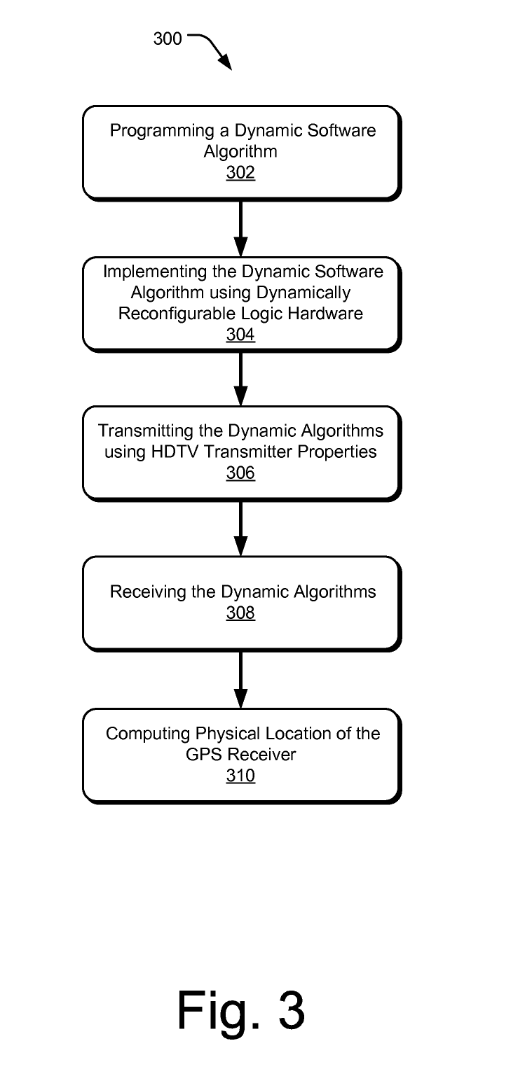

FIG. 3 is a flow chart diagram 300 for an exemplary process of computing a physical location in a GPS system. The order in which the method is described is not intended to be construed as a limitation, and any number of the described method blocks can be combined in any order to implement the method, or alternate method. Additionally, individual blocks can be deleted from the method without departing from the spirit and scope of the subject matter described herein. Furthermore, the method can be implemented in any suitable hardware, software, firmware, or a combination thereof, without departing from the scope of the invention.

At block 302, programming a dynamic software algorithm is performed. In an implementation, the dynamic software algorithm (e.g., dynamic software algorithm 206) is programmed to include a rapidly changing data patterns (i.e., dynamic algorithms), such as, data encrypting algorithms, data compressing algorithms, data rotating algorithms, data identification algorithms, and the like. The dynamic software algorithm 206 can be implemented in an HDTV transmitter (e.g., HDTV transmitters 106) and/or satellites (e.g., satellites 102).

At block 304, implementing the dynamic software algorithm using dynamically reconfigurable logic hardware is performed. In an implementation, the dynamically reconfigurable logic hardware (e.g., dynamic reconfigurable logic hardware 204) may be used to implement the dynamic software algorithm 206. In other implementations, an FPGA is used to implement the dynamic algorithm software 206 that includes the data encrypting algorithms, the data compressing algorithms, and the like. The FPGA can support the rapidly changing data patterns (i.e., dynamic algorithms) in the dynamic software algorithm 206 through configurable and/or reconfigurable logic block components. In another implementation, the logic block components (in the FPGA) can be dynamically configured and/or reconfigured partially without affecting the status and/or configuration of the rest of the logic block components in the FPGA.

At block 306, transmitting the dynamic algorithms using HDTV transmitter properties is performed. In an implementation, data streams to implement the rapidly changing algorithm in the dynamic software algorithm 206 are transmitted using the HDTV transmitter (e.g., HDTV transmitters 106) properties. In other implementation, a relatively high HDTV transmitting power (e.g., 100,000 watts) is used to transmit the data streams. The data streams that include the dynamic algorithms can be transmitted at VHF and UHF bands to penetrate obstacles (e.g., buildings, bunkers, etc.) that are within the line of sight of the HDTV transmitters 106.

At block 308, receiving the data streams containing the dynamic algorithms is performed. In an implementation, the GPS receiver (e.g., GPS receiver 104) receives the data streams that contain the dynamic algorithms. A reference timing clock that can be used by the GPS receiver 104 can be synchronized with the reference timing clocks that are used by the HDTV transmitters 106. In other implementations, the GPS receiver 104 uses the dynamic reconfigurable logic hardware 204 to decode rapidly changing data patterns in the received data streams. In addition, the GPS receiver 104 may at least distinguish, separate, and/or reject the other signals from other commercial HDTV transmitters (e.g., HDTV transmitters 106).

At block 310, computing physical location of a GPS receiver is performed. In an implementation, at least three or more signals (e.g., HDTV transmitter 106-2, HDTV transmitter 106-4, and GPS/HDTV transmitter 108 signals) are used to compute the physical location of the GPS receiver 104. The GPS receiver 104, as discussed above, can identify and distinguish the signals that were transmitted by the HDTV transmitters 106 and the GPS/HDTV transmitter 108. In other implementations, where the HDTV transmitters 106 are commercial HDTV transmitters, the synchronization of the reference timing clock is based on a portion of data streams (in the transmitted signals) that represents the start of a vertical retrace in an HDTV receiver. In other words, the starts of the vertical retrace in the data streams for commercial HDTV transmitters are synchronized relative to each other. The portion of data streams that represents the start of the vertical retrace can be used by the GPS receiver 104 as a reference for clock synchronization.

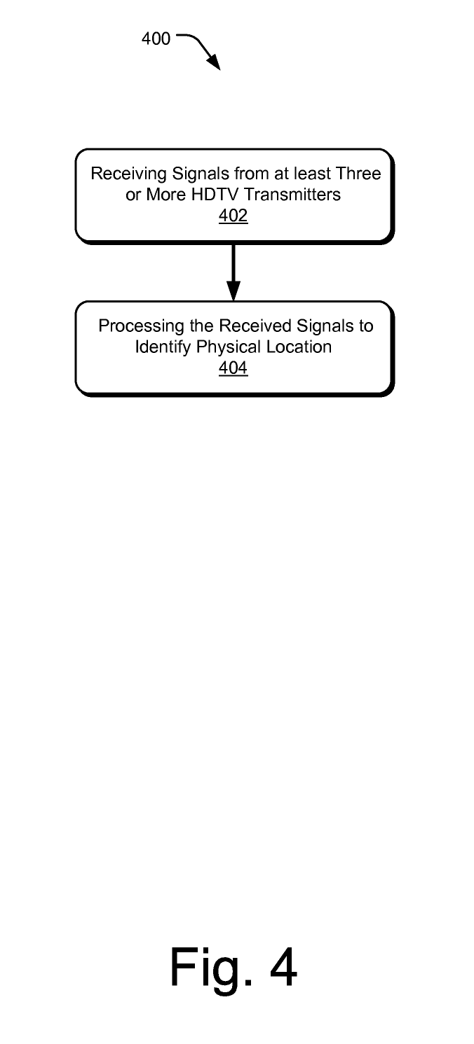

FIG. 4 is a flow chart diagram 400 for an exemplary process of computing a physical location for a GPS receiver. The order in which the method is described is not intended to be construed as a limitation, and any number of the described method blocks can be combined in any order to implement the method, or alternate method. Additionally, individual blocks can be deleted from the method without departing from the spirit and scope of the subject matter described herein. Furthermore, the method can be implemented in any suitable hardware, software, firmware, or a combination thereof, without departing from the scope of the invention.

At block 402, receiving signals from at least three or more HDTV transmitters is performed. In an implementation, a GPS receiver (e.g., GPS receiver 104) includes a processor (e.g., processor 202) that processes the signals from the three or more HDTV transmitters (e.g., HDTV transmitter 106-2, HDTV transmitter 106-4, and GPS/HDTV transmitter 108). In other implementations, the three or more signals may be received from satellites (e.g., satellites 102) in a GPS system.

At block 404, processing the received signals to identify physical location of a GPS receiver is performed. In an implementation, the processor 202 uses dynamic reconfigurable logic hardware (e.g., dynamic reconfigurable logic hardware 204) to decode dynamic data patterns in the received signals. The dynamic reconfigurable logic hardware 204 may be configured to process the dynamic data patterns in the received signals. In other implementations, the processor 202 computes the physical location of the GPS receiver 104 based from the signals received from the HDTV transmitters (e.g., HDTV transmitters 106).

### CONCLUSION

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims. For example, the systems described could be configured as networked communication devices, computing devices, and other electronic devices.

What is claimed is:

1. A global positioning system (GPS) system comprising:
at least three transmitters that transmit signals in a digital format, the transmitted signals containing data streams that include at least one of dynamic algorithm patterns or synchronized reference clocks; and
a GPS receiver configured to receive and process the transmitted signals to:
compute and identify GPS receiver's physical location; and
use the synchronized reference clocks as a reference timing clock; and
wherein the GPS receiver further includes a dynamic reconfigurable logic hardware to decode the dynamic algorithm patterns in the received signals, the dynamic reconfigurable logic hardware includes a partially reconfigurable logic block components to decode the dynamic algorithm patterns.

2. The GPS system of claim 1, wherein the transmitters include high definition television (HDTV) transmitters.

3. The GPS system of claim 1, wherein the dynamic algorithm pattern is implemented through a programmable dynamic software algorithm.

4. The GPS system of claim 1, wherein the transmitters and the GPS receiver include a synchronized timing clock for calculating the GPS receiver's physical location.

5. The GPS system of claim 1, wherein the synchronized reference clocks are used to adjust clock inaccuracies in the GPS receiver.

6. The GPS system of claim 5, wherein the synchronized reference clocks are based on a portion of data streams that include a synchronized start for a vertical retrace.

7. The GPS system of claim 5, wherein the synchronized reference clocks are based from an atomic clock on board a satellite in the GPS system.

8. The GPS system of claim 1, wherein the transmitted signals are transmitted at very high frequency (VHF) to ultra high frequency (UHF) bands.

9. The GPS system of claim 1, wherein the dynamic reconfigurable logic hardware is a field programmable gate array (FPGA).

10. A global positioning system (GPS) receiver device that includes:
a memory;
a processor coupled to the memory, which is configured to:
receive signals from at least three transmitters that transmit signals in a digital format, the transmitted signals containing data streams that include at least one of dynamic algorithm patterns or synchronized reference clocks, wherein the transmitted signals are transmitted at a high transmitting power; and
process the received signals to compute a physical location of the GPS receiver, wherein the GPS receiver further comprises a dynamic reconfigurable logic hardware to decode the dynamic algorithm patterns in the received signals.

11. The GPS receiver device of claim 10, wherein the transmitters are transmitting signals at a high definition television (HDTV) transmitting power and frequency bands.

12. The GPS receiver device of claim 10, wherein the dynamic algorithm patterns are used to secure the transmitted signals from the at least three transmitters.

13. The GPS receiver device of claim 10, wherein the HDTV transmitting power is at least one hundred thousand watts of transmitting power.

14. The GPS receiver device of claim 10, wherein the dynamic reconfigurable logic hardware is a field programmable gate array (FPGA).

15. The GPS receiver device of claim 14, wherein the FPGA includes a partially reconfigurable logic blocks to implement the dynamic algorithm patterns.

16. A computer-readable storage media having computer-readable instructions thereon which, when executed by a computer, implement a method comprising:
receiving signals from at least three transmitters that transmit signals in a digital format, the transmitted signals containing data streams that include at least one of dynamic algorithm patterns or synchronized reference clocks, wherein the transmitted signals are transmitted at a high transmitting power; and
processing the received signals to compute a physical location of a GPS receiver, wherein the GPS receiver further comprises a dynamic reconfigurable logic hardware to decode the dynamic algorithm patterns in the received signals

17. The computer-readable storage media of claim 16, wherein the transmitted signals in the digital format are produced by high definition television (HDTV) transmitters.

18. The computer-readable storage media of claim 16, wherein the transmitted signals in the digital format are produced by satellites stationed in an earth's outer orbit.

19. The computer-readable storage media of claim 16, wherein the synchronized reference clocks are based upon a portion of data streams in the transmitted signals that contain a synchronized start for a vertical retrace.

20. The computer-readable storage media of claim 16, wherein the transmitters are commercial high definition television (HDTV) transmitters.
